(19) United States
(12) Patent Application Publication
(10) Pub. No.: US 2003/0156788 A1
(43) Pub. Date: Aug. 21, 2003

(54) Method and device for recognizing dental caries, plaque, concrements or bacterial attacks

(76) Inventor: Thomas Henning, Langenfeld (DE)

Correspondence Address: JORDAN AND HAMBURG LLP, 122 EAST 42ND STREET, SUITE 4000, NEW YORK, NY, 10168, US

(21) Appl. No.: 10/363,871

(22) PCT Filed: Jun. 10, 2002
(86) PCT No.: PCT/EP02/06335

(30) Foreign Application Priority Data
Jul. 10, 2001 (DE) 101 33 451.6

(51) Int. Cl. G02B 6/00; G02B 6/26

(52) U.S. Cl. 385/31; 385/12

(57) ABSTRACT

Method and device for the detection of caries, plaque, calculus, bacterial attack, etc. in/on teeth, a radiation being generated using a light source and directed at a tooth to be examined, producing a reflected radiation there. The reflected radiation is detected and evaluated using a detection device. Advantageously, the tooth is irradiated using two or more wavelength ranges, the measured reflected intensities of the two wavelength ranges being related to one another as a characteristic value for the presence of caries, plaque, calculus, bacterial attack. As a supporting measure, the fluorescence radiation may also be evaluated.

The present invention relates to a method as well as to a corresponding device for the detection of caries, plaque, calculus, bacterial attack, etc. in/on teeth.

The detection of caries in teeth by visual examination or by X-rays is known. However, it is frequently not possible to achieve satisfactory results using a visual examination under white light illumination, since caries in an early stage or in tooth regions that are difficult to see, such as between the teeth and in gum pockets and furcations, can only be determined with difficulty if at all. Methods used in dental medicine until now do not allow any comprehensive and simple evaluation of the localization of calculus. The sole exception here is represented by surgical opening of gum pockets, since the work can be carried out here under direct visual inspection. However, this method is extremely painful for the patient to be treated. Although, on the other hand, X-rays have proven to be a very effective way of detecting caries or other tooth disease, this examination method is not optimal because of the harmful effects of the X-rays on human health, and early stages, in particular, are not recognized. There was therefore a need to develop a new technology, in order to be able to determine the presence of caries and calculus in/on teeth.

A contact-free examination method for detecting caries in human teeth was proposed in DE 30 31 249 C2, whereby the tooth is irradiated with almost monochromatic light. The almost monochromatic light radiation excites fluorescence radiation at the tooth. In this connection, it was discovered that the fluorescence spectrum emitted by the tooth demonstrates clear differences between carious and healthy tooth regions. For example, in the red spectral range of the fluorescence spectrum of the tooth, that is, between 550 nm and 650 nm, the intensity it clearly greater than in a healthy tooth, relative to a fluorescence signal at 450 nm. It was therefore proposed in DE 30 31 249 C2 that the tooth be irradiated at a wavelength of 410 nm and that the fluorescence radiation of the tooth be determined using two filters, for a first wavelength of 450 as well as for a second wavelength of 610 nm, that is, in the blue and the red spectral range, for example with the help of photodetectors. The fluorescence radiation intensities detected with this arrangement are subtracted, so that on the basis of the intensity differences obtained thereby, a healthy tooth region can be differentiated from a carious tooth region.

DE 42 00 741 A1 proposes, as an advantageous further development, that the fluorescence of the tooth be brought about by means of an excitation radiation at a wavelength ranging from 360 nm to 580 nm and that the fluorescence radiation produced at the irradiated tooth in the wavelength range between 620 nm and 720 nm be filtered out. By this measure, it is achieved that the distance between the wavelength of the excitation radiation and the received fluorescence radiation is sufficiently large, that the evaluation results cannot be distorted by the superimposition of the fluorescence radiations.

The examination methods and devices described above have in common that, in order to stimulate fluorescence at a tooth that is to be examined, an excitation radiation having a relatively short wavelength, that is, less than 580 nm, is used. It is true that in this way, a relatively large effective cross-section can be achieved for producing fluorescence radiation, particularly when wavelengths in the ultraviolet and blue range of the spectrum are used. However, the absolute fluorescence radiation of healthy tooth tissue in the red spectral range of the fluorescence spectrum is stronger than that of carious lesions.

It was therefore proposed in DE 195 41 686 A1 an excitation radiation having a wavelength between 600 nm and 670 nm be used to excite fluorescence at a tooth to be examined. To detect the fluorescence radiation excited at the irradiated tooth, a spectral filter arrangement is used, which permits the transmission of fluorescence radiation having a wavelength greater than 670 nm. According to DE 195 41 686 A1 therefore, only fluorescence radiation having a wavelength greater than 670 is evaluated for the detection of caries, plaque, or bacterial attack in/on the irradiated tooth.

The known examination methods described above, which are based on the evaluation of fluorescence radiation, all have the problem that the reliability of the examination is inadequate. Either a complicated direct comparison of the fluorescence radiation emitted in a specific wavelength range by adjacent healthy and carious regions is required, which can result in further sources of error, particularly when measurements are made at various points, or the measurement signals of the fluorescence radiation emitted in two different wavelength ranges must be compared with one another in a complicated process. The methods based on fluorescence have only a low signal intensity, which makes it necessary to use of expensive detectors such as photomultipliers. These devices cannot be produced economically, because of their complicated structure, and cannot prevail on the market. If only a single spectral range is selected, which can be easily detected because the background radiation of healthy tissue can be ignored, the low amount of information is a decisive disadvantage and can result in incorrect diagnoses, if dental filling materials lie within the examination region. Because of the many different types of tissue and artificial materials that occur in the mouth, a diagnosis that is based only on the analysis of fluorescence radiation using one or two spectral ranges is inadequate.

Proceeding from the state of the art as described above, the present invention is based on the task of increasing the evaluation reliability further for the detection of caries, plaque, calculus, or bacterial attack in/on teeth. In particular, incorrect diagnoses due to fluorescing dental filling materials are intended to be avoided. In addition, the effort and expense, in terms of equipment technology, for the detection of pathological changes in the tooth are to be reduced, and simple battery operation is to be possible.

Pursuant to the invention, this objective is accomplished, by a method having the distinguishing features of claim 1 and by a device having the distinguishing features of claim 25. The dependent claims describe preferred and advantageous embodiments of the present invention, which in turn contribute to an improved sensitivity or to a device with as simple and compact a structure as possible.

The invention is based on the discovery that reflected signals can be used to detect caries, plaque, calculus, or bacterial attack in/on teeth. In the wavelength above approximately 650 nm, the reflection from cementum, in other words from healthy tooth substance, is approximately equal to the reflection from a thin calculus layer. In the wavelength range below approximately 650 nm, on the other hand, the reflection from cementum is greater than the reflection from a thin calculus layer. In contrast, the reflection from a thick calculus layer is significantly greater in the wavelength range above approximately 600 nm than the reflection from cementum. In the wavelength below approximately 500 nm, in turn, the reflection from cementum is greater than the reflection from a thick calculus layer.

The intensity of reflection signals is significantly greater than that of fluorescence signals, so that complicated illumination and detection systems are not required. If the fluorescence signal is split and assessed in two different spectral ranges, the low detection intensity in at least one spectral range, namely the red range, is a disadvantage. The present invention circumvents this disadvantage in that the fluorescence emission is detected over its entire spectral range, or at least in a range of high signal intensity, and related to one or two significantly stronger reflection signals and not to a weaker fluorescence signal.

The absolute value of the measured reflection is determined by the distance between the probe and the sample. An angle between the probe and the sample leads to a reduction in the measured reflection, preferably in the long-wavelength spectral range. Since reflection signals are influenced markedly by the surface geometry of the sample and the incident angle, it is advantageous to compare at least two wavelengths by means of a reflection spectroscope, so that standardization is achieved.

An analysis of the fluorescence radiation excited can also be evaluated, as a complementary measure, in order to support the evaluation in critical regions.

The low photon yield and therefore the low signal-to-noise ratio are the main problems of auto-fluorescence measurements. In order to achieve a maximum photon yield, the work should be carried out with immersion. For in vivo measurements, water or physiological saline solution appears to be suitable (N.A. in the visible spectral range, 37° C.>1.33). The signal quality is influenced not only by the geometrical optics and the primary sensor material, but also by the suitable amplifier technology. A lock-in amplifier is suitable for detecting modulated signals in a specific frequency and phase. All non-synchronous noise, such as background illumination from the overhead lamp, is effectively eliminated. This leads to a rediscovery of signals, which were buried in noise by more than 60 dB.

In the following, the present invention is explained in greater detail with reference to the attached drawings, in which

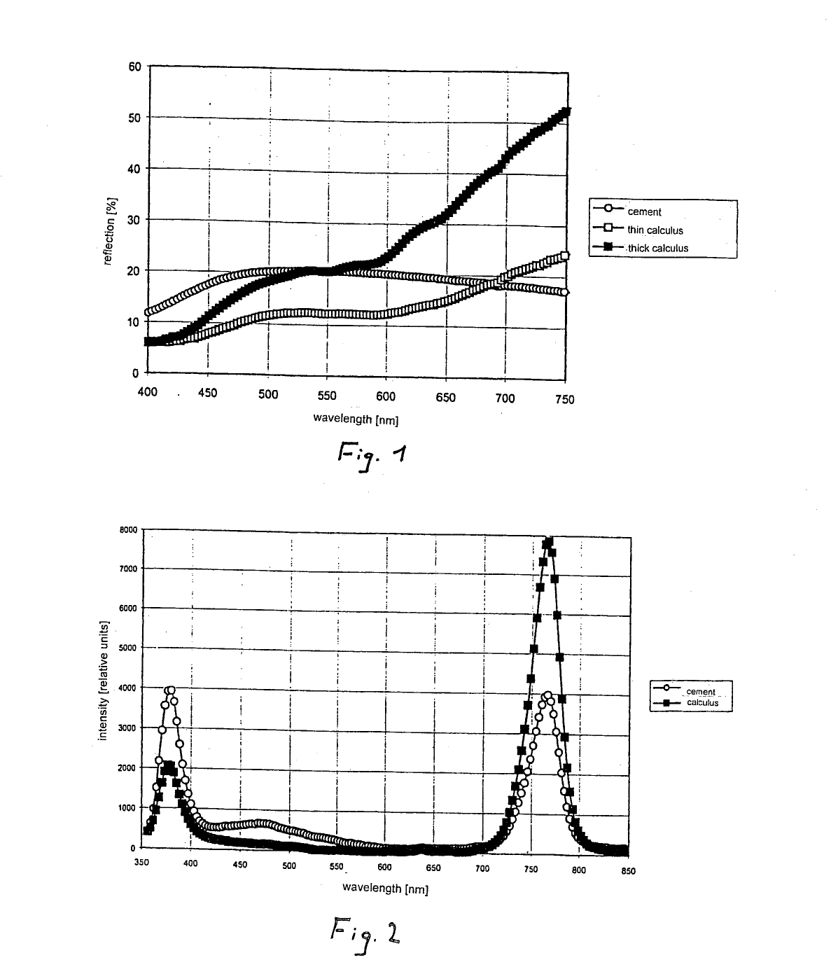

FIG. 1 shows a reflection spectrum of the healthy tooth substance of a thin calculus layer and of a thick calculus layer, at wavelengths ranging from 400 nm to 750 nm, the tooth to be examined being irradiated with wavelengths within the entire range,

FIG. 2 shows the variation in intensity of the radiation reflected from healthy tooth substance and from a calculus layer in the wavelength range of 350 nm to 800 nm; the tooth to be examined was irradiated with wavelengths around 370 nm and around 770 nm,

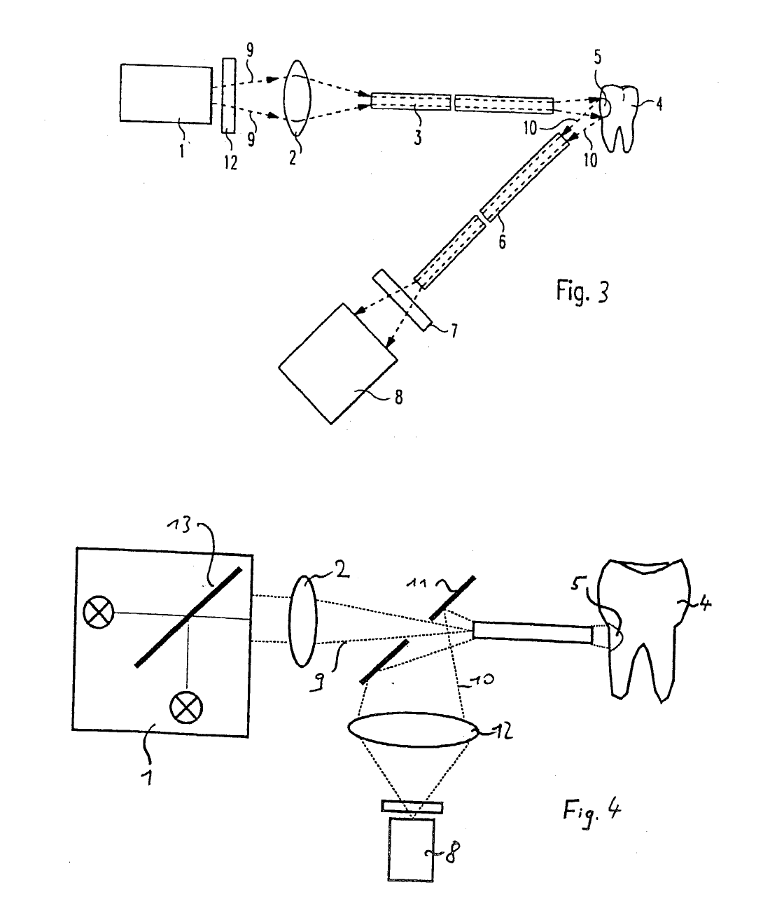

FIG. 3 shows a preferred embodiment of an inventive device for the detection of caries, plaque, calculus, or bacterial attack in/on teeth,

FIG. 4 shows a preferred embodiment of an inventive device, for the detection of caries, plaque, calculus, or bacterial attack in/on teeth,

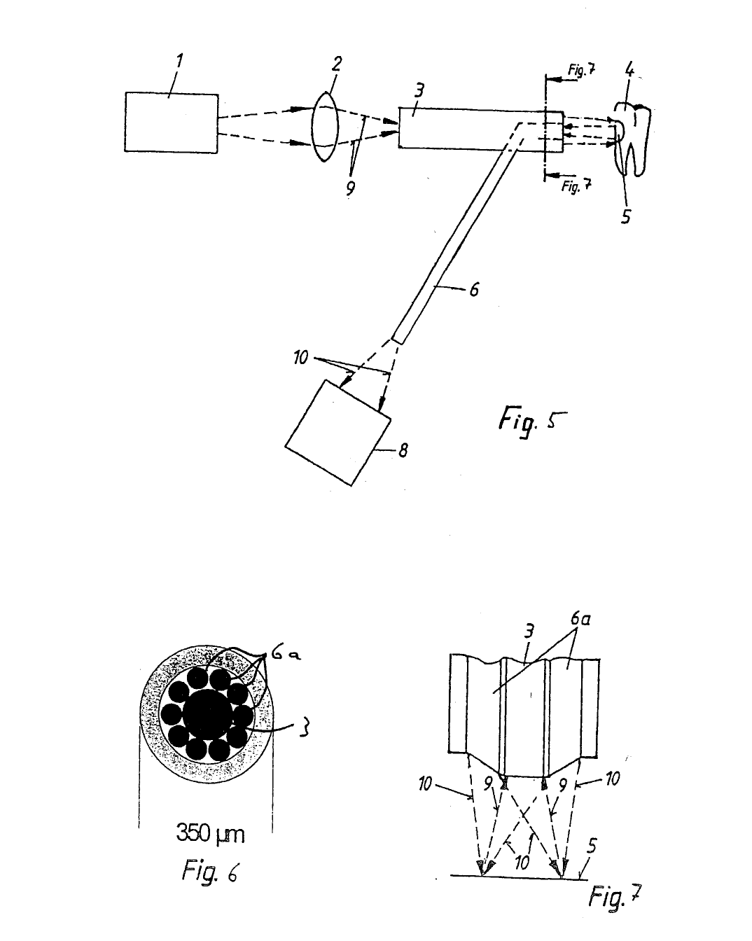

FIG. 5 shows a preferred embodiment of an inventive device, for the detection of caries, plaque, calculus, or bacterial attack in/on teeth,

FIG. 6 shows a cross-section through a preferred embodiment of an inventive probe,

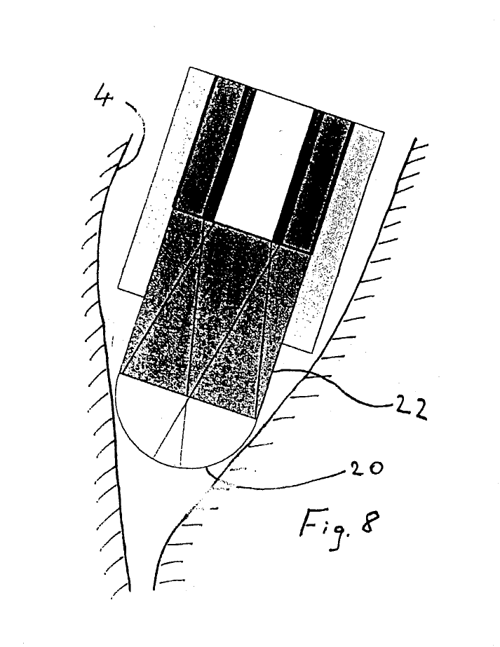

FIG. 7 shows a side view of a preferred embodiment of an inventive probe, and

FIG. 8 shows a side view of another preferred embodiment of an inventive probe.

FIG. 1 shows a reflection spectrum of the healthy tooth substance of a thin calculus layer and of a thick calculus layer, at wavelengths ranging from 400 nm to 750 nm. In the range above approximately 650 nm, the reflection from cementum, in other words from healthy tooth substance, is approximately equal to the reflection from a thin calculus layer. In the wavelength below approximately 650 nm, on the other hand, the reflection from cementum is greater than the reflection from a thin calculus layer. FIG. 1 also shows that the reflection from a thick calculus layer is already significantly greater than the reflection from cementum in the wavelength range above approximately 600 nm. In the wavelength below approximately 500, in turn, the reflection from cementum is greater than the reflection from a thin calculus layer. The invention takes advantage of this discovery, by utilizing the different reflection behavior as a criterion for the presence of calculus. In this connection, it has been shown that the signal intensity of the reflection signals is significantly greater than that of fluorescence signals.

According to a preferred embodiment, the tooth is irradiated with radiation consisting of two wavelengths, that is, two wavelength ranges, approximately in the blue and ultraviolet light range from 320 to 520 nm, particularly 370 nm, and with red or near-red infrared light above 600 nm, particularly 770 nm; the reflection intensities of the same wavelength ranges are measured.

FIG. 2 shows the variation in the intensity of the signal reflected from healthy tooth substance and from a thick calculus layer at wavelengths ranging from 350 nm to 800 nm. The tooth to be examined was irradiated with wavelengths ranging from about 370 nm to about 770 nm. The radiation intensities within the two wavelength ranges were selected in such a way that the magnitude of the signal reflected from healthy cementum is approximately the same in both wavelength ranges, in other words, the radiation intensity in the near UV spectral range is approximately twice as high as that in the NIR spectral range. In agreement with FIG. 1, the reflection from calculus is less in the near UV spectral range and a higher in the NIR spectral range than that of healthy cementum. In addition to the reflected radiation, cementum has a fluorescence radiation in the blue-green spectral range, with a maximum around 470 nm; on the other hand, calculus has almost no fluorescence.

For the evaluation, the measured reflection intensity at a wavelength of 770 nm is related to the measured reflection intensity at a wavelength of 370 nm. At ratio values of greater than 2, the presence of calculus can be affirmed clearly. At values around 1, cementum, in other words healthy tooth substance, is clearly present. As a supplement, the fluorescence effect can be used to confirm the results of the reflection analysis, or, in case of doubt, to serve as an additional decisive criterion for the presence of calculus. In this connection, the radiation used for the analysis of the reflection behavior can also be used to excite the fluorescence, as in the present case. According to a preferred embodiment, excitation of the fluorescence takes place by means of radiation having a wavelength around 370 nm, so that it is only necessary to irradiate with only two wavelength ranges.

The absolute magnitude of the reflection measured is determined by the distance between the probe and the sample. If the angle between the probe and the sample deviates from 0°, the measured reflection is reduced. Since reflection signals are markedly influenced by the surface geometry of the sample and the angle of incidence, it is also advantageous to compare at least two wavelengths by means of reflection spectroscopy. In this way, standardization makes it possible to achieve a high level of evaluation reliability independently of the absolute magnitude of the measured individual signals.

The intensity measured at 770 nm therefore serves as a relative reference value, so that standardization is possible. In this way, a comparison with healthy adjacent tooth substance becomes superfluous, since a reliable result can also be achieved at single points. However, a point by point measurement is particularly advantageous, if the neck region of the tooth in periodontal pockets is being examined, since a probe with the smallest possible diameter can be inserted there between the neck of the tooth and the gum, in order to avoid cutting the gum to investigate whether the region is diseased.

Pursuant to the present invention, scattering, absorption, and fluorescence are detected jointly in each instance in the regions of greatest signal intensities: high preferential absorption in the ultraviolet range, high fluorescence intensity in the blue-green spectral range, and almost unreduced reflection in the near infrared range. The use of short-wave excitation light results in a highly effective cross-section for the generation of fluorescence radiation in the blue-green spectral range and therefore also in high signal intensity. Healthy areas fluoresce significantly more strongly than changed regions of teeth in this range.

Simple narrow-band sources of illumination, such as narrow-band light-emitting diodes, can be used. The detection can also be carried out very easily by means of commercially available three-element color sensors, which have specific sensors for the basic colors of red, green, and blue, that is, by means of so-called RGB photodiodes. In this connection, the most informative range for the evaluation can be selected within the three spectral ranges red, green, and blue, by means of the appropriate radiation. The three sensors for the basic colors red, green, and blue are usually arranged in a circle, a 120′ segment of the circle being assigned to each sensor for a specific basic color.

In order to be able to discriminate clearly between pathologically changed tooth regions and dental filling materials, it is advantageous to use more than two wavelength ranges for the evaluation. In this connection, either two wavelength ranges for the reflection analysis and one wavelength range for the fluorescence analysis can be used, as is the case in the preferred embodiment described above, or three or more reflected wavelength ranges and/or fluorescence wavelength ranges can be used.

In the near infrared range, the absorption of radiation in biological materials can be ignored. There is a so-called biological window, so that the reflected radiation is determined only by the scattering properties and not by the absorption of the tooth region being examined. The radiation reflected from the tooth surface of healthy tooth substance is approximately the same as that reflected from thin calculus in this range (see FIG. 1), so that the intensity of the fluorescing radiation, as well as the intensity of the reflected blue or green radiation, reduced by absorption, can be standardized to this value. Because the transmission of the lower-lying healthy tooth regions is greater than that of the lower-lying bacterially changed tooth regions, the lower-lying layers of healthy tooth substances reflect hardly at all, whereas lower-lying calculus layers still make a significant contribution to the reflection signal.

FIG. 3 shows a first embodiment of an inventive device, for the detection of caries, plaque, calculus or bacterial attack in/on teeth. A light source 1 generates a radiation 9, which is passed to a region 5 of a tooth 4 to be examined, by way of an input lens system 2 and a supplying optical fiber 3. The tooth 4 is irradiated with a radiation 9, which consists of two separate wavelength ranges, according to a preferred embodiment. In this connection, the first wavelength range can lie approximately in the blue or ultraviolet light range from 320 nm to 520 nm, particularly at approximately 370 nm. The second wavelength range can preferably lie in the red or in the near infrared wavelength range above 600 nm, particularly above 770 nm. The radiation 9 causes a reflected radiation 10, which likes in the same wavelength ranges, at the tooth 4. Furthermore, a fluorescence radiation of the tooth is excited, which can also be evaluated, according to a preferred embodiment. The reflected radiation 10 can be passed to the detection device 8 by way of an output optical fiber 6. After detection of the measured reflection signals, the inventive evaluation, which was explained above, takes place.

The light source 1 preferably comprises one or more light-emitting diodes, particularly narrow-band light-emitting diodes, which generate light in the wavelength range around approximately 370 nm and around approximately 770 nm. However, one or more lasers can also be used. As shown in FIG. 4, it is possible, in the case of these embodiments, to use one or more beam splitters 13, in order to couple radiation from additional light-emitting diodes or from other lasers accurately into the supplying optical fiber. Furthermore, it is possible to use a light source, which generates radiation having a wavelength range of approximately 320 nm to approximately 900 nm, particularly a wavelength range of white light. In this connection, a spectral filter can also be used to obtain a desired wavelength range for the radiation 9.

The detection device 8 comprises one or more sensors, which have their maximum sensitivity in different wavelength ranges, in each instance. It is particularly advantageous to use the three sensors to measure the intensities of the first reflected wavelength range, the second wavelength range, and the fluorescence wavelength range, the sensors being adapted to these wavelength ranges. It has been shown that even commercially available RGB photodiodes with three light-sensitive sensors for the basic colors red, green, and blue are suitable for inventive device. A spectrally selective element 7 can also be disposed ahead of the detection device 8.

FIG. 4 shows another embodiment of an inventive device, for the detection of caries, plaque, calculus, or bacterial attack in/on teeth. Differing from the device shown in FIG. 3, a mirror 11 is used, which has a round or elliptical opening in its center. The radiation 9 is coupled into an optical fiber by way of the input lens system 2, through the opening of the mirror, and the reflected radiation 10 is passed on to the detection unit 8 by way of the mirror 11 and by way of another input lens system 12. The result achieved in this way is that it is possible to use only a single optical fiber.

FIG. 5 shows another embodiment of an inventive device, for the detection of caries, plaque, calculus, or bacterial attack in/on teeth. In this device, one or more output fiber optic light guides 6 are placed centered in a probe, and one or more supplying fiber optic light guides 3 are arranged around the output fiber optic light guides 6, distributed over the circumference. This arrangement is made possible only by the fact that the signal intensity of reflected signals evaluated is significantly greater than that of fluorescence signals.

FIG. 6 shows a cross-section in the region of an inventive probe. An output optical fiber 3 is arranged in the center, while ten supplying fiber optic light guides fibers 6a are arranged around the output optical fiber 3. The corresponding radiation variations are shown in FIG. 7. However, it is also possible to arrange the supplying and output optical fibers along a line, the supplying optical fibers 6a being arranged laterally on the output optical fibers 3. A point by point measurement is achieved with this arrangement of the output optical fibers, so that the accuracy of the measurement is increased, because, at the same time, when the measurement region is enlarged, regions with healthy tooth substance and regions, in which calculus is present, can be mixed and thus lead to further sources of error. In addition, the probe can be designed to be very compact, so that it is suitable for being introduced into the gum pocket between the neck of the tooth and the gum. In this way, it becomes unnecessary to cut the gum open for an examination.

FIG. 8 shows another preferred embodiment of an inventive probe. An input lens system 20, in this embodiment a lens in the shape of a hemisphere, is arranged at the end of the fiber optic light guide. It is advantageous if a spacer 22 is used, so that the region to be examined does not have the shadow of the optical fibers falling on it. This spacer 22 is either hollow or solid and made of quartz glass, and can be provided with a reflective surface around its cylindrical circumference. In the tip region of the probe, a further mirrored surface (21) can be provided, in order to guarantee lateral deflection of the radiation. When the probe is pushed into the gum pocket and the fiber optic light guides are arranged approximately parallel to the surface of the tooth, the irradiation of the tooth surface to be examined is optimum, as is optimal input of the reflected radiation or the fluorescence radiation into the output fiber optic light guide.

In addition, a device for supplying a liquid can be provided at the probe tip, in order to supply liquid to the probe tip. In particular, such a device is a flushing channel with an outlet opening. In this way, it is achieved that, on the one hand, the blood is flushed away from the probe, on the other hand, that the refractive index can be advantageously influenced when the radiation exits from the.

1. Method for the detection of caries, plaque, calculus, bacterial attack, etc. in/on teeth, comprising the steps of
a) irradiating a tooth (4) to be examined or a region (5) of the tooth surface to be examined with a radiation (9),
b) detecting the radiation, which emanates from the tooth (4) to be examined or from the region (5) of the tooth surface to be examined, and
c) evaluating the detected radiation, which was reflected from the tooth (4) to be examined or from the region (5) of the tooth surface to be examined because of the irradiation with the radiation (9).

2. Method of claim 1, wherein, in step a), the tooth (4) to be examined or the region (5) of the tooth surface to be examined is irradiated with a radiation comprising one or more wavelength ranges, particularly a first wavelength range, a second wavelength range, and/or a third or additional wavelength ranges.

3. Method of claims 1 or 2, wherein in step a), the irradiation of the tooth (4) to be examined or the region (5) of the tooth surface to be examined takes place with a radiation that comprises a first wavelength range that lies below approximately 550 nm, particularly below approximately 500 nm.

4. Method of one of the preceding claims, wherein in step a), the tooth (4) to be examined or the region (5) of the tooth surface to be examined is irradiated with radiation, which comprises a second wavelength range lying above approximately 600 nm, particularly above approximately 700 nm, particularly above approximately 770 nm.

5. Method of one of the preceding claims, wherein in, step a), the tooth (4) to be examined or the region (5) of the tooth surface to be examined is irradiated with radiation, which comprises a first wavelength range that lies within the spectral range between approximately 320 nm and 520 nm, particularly approximately at 370 to 420 nm.

6. Method of one of the preceding claims, wherein, in step c), only those wavelength ranges of the reflected radiation are evaluated with which the irradiation was carried out in step a).

7. Method of one of the preceding claims, wherein, in step c), for the evaluation of the reflected radiation (10), the corresponding intensities of the reflected wavelength ranges are related to one another as a characteristic value indicating whether caries, plaque, calculus and/or bacterial attack are present in/on the tooth to be examined.

8. Method of one of the preceding claims, characterized by the steps of detection and evaluation of the fluorescence radiation produced at the tooth (4) by the irradiation in step a), in order to have a measurement signal, additional to the evaluation of reflection in step c), available for the detection of caries, plaque, calculus, bacterial attack, etc. in/on teeth.

9. Method of claim 8, wherein a wavelength range of the radiation used in step a) is used to excite the fluorescence radiation emanating from the irradiated tooth.

10. Method of one of the preceding claims, wherein the irradiation with the respective wavelength ranges takes place simultaneously.

11. Method of one of the preceding claims, wherein the reflected radiation and/or the fluorescence radiation are detected simultaneously.

12. Method of one of the preceding claims, wherein the irradiation with the wavelength ranges, in each instance, takes place with a time offset.

13. Method of one of the preceding claims, wherein the detection of the reflected radiation and/or the fluorescence radiation takes place with a time offset.

14. Method of one of the preceding claims, wherein, in step a), the radiation is generated by one or more light-emitting diodes, particularly by narrow-band light-emitting diodes.

15. Method of one of the preceding claims, wherein, in step a), the radiation is generated by means of one or more lasers, particularly by means of one or more diode lasers.

16. Method of one of the preceding claims, wherein, in step a), the radiation comprises a wavelength range of approximately 320 nm to 900 nm and particularly a wavelength range of white light.

17. Method of one of the preceding claims, wherein the radiation, which emanates from the tooth (4) to be examined or from the region (5) of the tooth surface to be examined, passes through one or more spectral filter means, particularly selective spectral elements, interference filters, band filters, or grids.

18. Method of one of the preceding claims, wherein the radiation, which emanates from the tooth (4) to be examined or the region (5) of the tooth surface to be examined, passes through one or more prisms and/or one or more beam splitters, particularly dichroitic beam splitters.

19. Method of one of the preceding claims, wherein the detection, which takes place in step b), takes place by means of one or more light-sensitive sensors.

20. Method of one of the preceding claims, wherein the detection, which takes place in step b), takes place by means of a color sensor having at least two light-sensitive sensors to measure the intensities of the first, second, and/or third reflected or emitted wavelength range.

21. Method of one of the preceding claims, wherein the detection, which takes place in step b), takes place by means of a spectrometer.

22. Method of one of the preceding claims, wherein the detection. Which takes place in step b), takes place by means of a color sensor having three light-sensitive sensors to measure the intensities of the first reflected wavelength range, the reflected second wavelength range and the fluorescence wavelength range or the reflected third wavelength range, particularly having three light-sensitive sensors for the basic colors of red, green, and blue, particularly RGB photodiodes, the signals of the light-sensitive sensors for the basic colors red, green, and blue being used to evaluate the tooth color.

23. Method of one of the preceding claims, wherein the detection, which takes place in step c), takes place by means of a plurality of sensors, which are disposed along a line or along a curve.

24. Method of one of the preceding claims, wherein the detection, which takes place in step c), takes place by means of a plurality of sensors, which are disposed within a two-dimensional surface, particularly by means of an image sensor, particularly by means of a CCD chip or a CMOS chip, the optical fibers being assigned to the sensors or pixel elements, in each instance, in order to obtain an image of the region to be examined.

25. Device for the detection of caries, plaque, calculus, bacterial attack, etc. in/on teeth, comprising
one or more light sources (1) to generate a radiation (9), which can be directed onto a tooth or tooth surface (4, 5) to be examined, and
a device (8) for detecting the radiation (10), which is sent back from the tooth (4) to be examined or from the region (5) of the tooth surface to be examined, particularly reflected.

26. Device of claim 25, wherein the one or the several light sources (1) generate/s a radiation (9) that comprises one or more wavelength ranges, particularly a first wavelength range, a second wavelength range, and/or a third wavelength range, these wavelength ranges in particular, being separated from one another, so that they do not overlap spectrally.

27. Device of claims 25 or 26, wherein the one or the several light sources (1) generate/s a radiation having a first wavelength range, which lies below approximately 550 nm and particularly below approximately 500 nm.

28. Device of one of the preceding claims, wherein the one or the several light sources (1) generates a radiation (9) having a second wavelength range, which is above approximately 600 nm, particularly above approximately 700 nm and especially above approximately 770 nm.

29. Device of one of the preceding claims, wherein the one or the several light sources (1) generates a radiation (9) within a wavelength range between approximately 320 nm and 520 nm particularly between approximately 370 to 420 nm.

30. Device of one of the preceding claims, wherein the device (8) for detecting the radiation is suitable or adapted for detecting the wavelength ranges generated by the one or by the several light sources (1).

31. Device of one of the preceding claims, wherein the device (8) for detecting the radiation comprises one or more sensors, the maximum sensitivities of which are in different wavelength ranges.

32. Device of one of the preceding claims, wherein the device (8) for detecting the radiation comprises one or more sensors, the maximum sensitivity of which is approximately in the fluorescence wavelength range(s), which is/are generated by the one or the several light sources (1).

33. Device of one of the preceding claims, wherein the device furthermore comprises an evaluation device, particularly a processor, for evaluating the reflected radiation (10), the evaluation device being suitable for relating the corresponding intensities of the reflected wavelength ranges to one another as characteristic values indicating whether caries, plaque, calculus, and/or bacterial attack is present in/on the tooth to be examined.

34. Device of one of the preceding claims, wherein the device (8) for detecting the radiation is suitable for detecting the reflected radiation (10) and/or the fluorescence radiation simultaneously.

35. Device of one of the preceding claims, wherein the device (8) for detecting the radiation is suitable for detecting the reflected radiation (10) and/or the fluorescence radiation with a time offset.

36. Device of one of the preceding claims, wherein a device is present for irradiating the tooth (4) to be examined or the region (5) of the tooth surface to be examined with a time offset, particularly a mobile mirror arrangement, a mobile prism arrangement, a filter wheel or a switching device for alternately switching the individual light sources on and off.

37. Device of one of the preceding claims, wherein one or more supplying optical fibers (3) is/are provided for supplying the radiation emitted by the light source (1) towards the tooth or tooth surface (4, 5) to be examined, the supplying optical fiber or the supplying optical fibers (3) being optically connected with the light source(s) (1).

38. Device of one of the preceding claims, wherein one or more output optical fibers (6) is/are provided for conducting the radiation emitted from the tooth surface (5) to be examined to the device (8) for detecting radiation, the output optical fiber or the output optical fibers (6) being optically connected with the device (8) for detecting radiation.

39. Device of one of the preceding claims, wherein one or more optical fibers (3) are provided for conducting the radiation emitted from the tooth surface (5) to be examined, to the device (8) for detecting radiation, and for supplying the radiation emitted by the light source (1) to the tooth or tooth surface to be examined, the one or more optical fibers (3) being optically connected with the light source(s) (1) and with the device (8) for detecting radiation.

40. Device of one of the preceding claims, wherein a mirror (11) is disposed between the light source(s) (1) and the one or more optical fibers (3) and has an opening, particularly an elliptical one, or a non-mirrored part in the center region, the mirror, in particular, having a flat, elliptical, or parabolic shape.

41. Device of one of the preceding claims, wherein the reflected radiation (10) is passed to the detection device (8) by way of an input system (12).

42. Device of one of the preceding claims, wherein the one or more supplying optical fibers (3) and the one or more output optical fibers (5) lead into or end in a probe.

43. Device of one of the preceding claims, wherein the one or more output optical fibers (6) are centered in the probe and the one or more supplying optical fibers (3) are arranged around the output optical fibers (6), distributed over the circumference.

44. Device of one of the preceding claims, wherein the one or more output optical fibers (6) are centered in the probe, and the one or more supplying optical fibers (3) are arranged to the side, particularly to the right and to the left of the output optical fibers (6), so that the supplying and the output optical fibers are arranged in a line.

45. Device of one of the preceding claims, wherein the ends of the optical fibers are beveled in the region of the probe, particularly only in one direction.

46. Device of one of the preceding claims, wherein an input system, particularly a lens and/or a mirror, is arranged at the probe.

47. Device of one of the preceding claims, wherein a spacer (22) is arranged on the probe, particularly between the input system (20) and the end(s) of the optical fibers.

48. Device of one of the preceding claims, wherein the spacer (22) arranged on the probe, is a solid or hollow cylinder, which can be provided with a mirrored surface around its cylindrical circumference.

49. Device of one of the preceding claims, wherein a mirror, particularly a flat, an elliptical, or a parabolic mirror, is arranged on the probe, the mirror being arranged particularly either at the tip of the probe or between the input system (20) and the end of the optical fibers.

50. Device of one of the preceding claims, wherein the axis of the mirror on the probe is arranged at an angle, preferably of approximately 45°, to the axis of the optical fibers,

51. Device of one of the preceding claims, wherein a prism is arranged at the ends of the optical fibers, particularly a 90° deflection prism with a mirrored hypotenuse.

52. Device of one of the preceding claims, wherein the one or the several light sources (1) are one or more light-emitting diodes, particularly narrow-band light-emitting diodes.

53. Device of one of the preceding claims, wherein the one or more light sources (1) are one or more monochromatic light sources, particularly lasers and/or diode lasers, particularly in the VCSEL version (Vertical Cavity Surface Emitting Laser).

54. Device of one of the preceding claims, wherein one or more beam splitters are provided at the light sources, in order to achieve accurate coupling into the optical fiber(s) by means of superimposition of the radiation generated.

55. Device of one of the preceding claims, wherein the one or more light sources (1) generate a wavelength range of approximately 320 nm to approximately 900 nm, particularly a wavelength range of white light.

56. Device of one of the preceding claims, wherein one or more spectral filtering agents, particularly spectrally selective elements, interference filters, band filters or grids, are arranged ahead of the device (8) for detecting radiation.

57. Device of one of the preceding claims, wherein one or more prisms and/or one or more beam splitters are arranged ahead of the device (8) for detecting radiation.

58. Device of one of the preceding claims, wherein the device (8) for detecting radiation comprises one or more light-sensitive sensors.

59. Device of one of the preceding claims, wherein the device (8) for detecting radiation comprises a color sensor having at least two light-sensitive sensors for measuring the intensities of the first, second, and/or third reflected wavelength ranges.

60. Device of one of the preceding claims, wherein the device (8) for detecting radiation comprises a color sensor with three light-sensitive sensors to measure the intensities of the first reflected wavelength range, the reflected second wavelength range and the fluorescence wavelength range or the reflected third wavelength range, the sensors being adapted to these wavelength ranges, particularly with three light-sensitive sensors for the basic colors red, green, and blue, particularly RGB photodiodes, the processor being suitable for determining the tooth color on the basis of the three light-sensitive sensors for the basic colors red, green, and blue.

61. Device of one of the preceding claims, wherein the device (8) for detecting radiation is a spectrometer, particularly a microspectrometer.

62. Device of one of the preceding claims, wherein the device (8) for detecting radiation comprises a plurality of sensors, which are disposed along a line or along a curve.

63. Device of one of the preceding claims, wherein the device (8) for detecting radiation comprises a plurality of sensors that are arranged within a two-dimensional surface, particularly a CCD chip or a CMOS chip, the optical fibers being assigned to the sensors or pixel elements in each instance, in order to obtain an image of the region to be examined.

64. Device of one of the preceding claims, wherein the device (8) for detecting radiation comprises a lock-in amplifier.

65. Device of one of the preceding claims, wherein the device (8) for detecting radiation comprises a radiation converter for shifting the wavelength range of the reflected radiation or the fluorescence radiation into a wavelength range, which is more suitable for detection by the sensors, particularly for shifting the fluorescence radiation from the blue-green wavelength range into the green wavelength range.

66. Device of one of the preceding claims, wherein a device for supplying a liquid is provided, in order to supply the probe tip with this liquid, particularly a flushing channel with an outlet opening at or in the region of the probe tip.

67. Probe for supplying radiation (9) to a region (5) to be examined and for conducting radiation (10) away from the region (5) to be examined, comprising one or more optical fibers (3; 6).

68. Probe of claim 67, wherein the one or the several optical fibers comprise supplying optical fibers (3), which are provided for supplying the radiation (9).

69. Probe of claim 67 or 68, wherein the one or the several optical fibers comprise output optical fibers (6), which are provided for conducting away the radiation (10) given off by the region to be examined.

70. Probe of claim 67, wherein the one or the several optical fibers (3) is/are provided for conducting away the radiation (10) given off by the region to be examined and for supplying the radiation (9).

71. Probe of one of the preceding claims, wherein the one or the several output optical fibers (6) are centered in the probe and the one or more supplying optical fibers (3) are arranged around the output optical fibers (6), distributed over the circumference.

72. Probe of one of the preceding claims, wherein the one or the several output optical fibers (6) are centered in the probe, and the one or more supplying optical fibers (3) are arranged to the side, particularly to the right and to the left of the output optical fibers (6), so that the supplying and the output optical fibers are arranged in a line.

73. Probe of one of the preceding claims, wherein the ends of the optical fibers are beveled in the region of the probe, particularly only in one direction.

74. Probe of one of the preceding claims, wherein an input system, particularly a lens in the shape of a hemisphere is disposed at the probe.

75. Probe of one of the preceding claims, wherein a mirror, particularly a flat, elliptical, or parabolic mirror, is arranged on the probe, the mirror being arranged particularly either at the tip of the probe or between the input system (20) and the end of the optical fibers, or directly one the one or the several beveled surfaces of the optical fibers.

76. Probe of one of the preceding claims, wherein the axis of the mirror is arranged on the probe at an angle, preferably approximately 45°, to the axis of the optical fibers,

77. Probe of one of the preceding claims, wherein a prism is arranged at the ends of the optical fibers, particularly ahead of or after the input system (20).

78. Probe of one of the preceding claims, wherein a spacer (22) is arranged at the probe, particularly between the input system (20) and the end(s) of the optical fibers.

79. Probe of one of the preceding claims, wherein the spacer (22), arranged on the probe, is a solid or hollow cylinder, which can be provided with a mirrored surface around its cylindrical circumference.

80. Probe of one of the preceding claims, wherein a device for supplying a liquid, particularly a flushing channel with an outlet opening at or in the region of the probe tip, is provided, in order to supply the probe tip with this liquid.
